(19) United States
(12) Patent Application Publication
(10) Pub. No.: US 2005/0208807 A1
(43) Pub. Date: Sep. 22, 2005

(54) Hinge structure of a folder-type cell phone and an assembling method thereof

(75) Inventor: Yi-Yan Lin, Taipei City (TW)

Correspondence Address: Ladas & Parry, 26 West 61st Street, New York, NY, 10023, US

(73) Assignee: BENQ CORPORATION

(21) Appl. No.: 11/076,509

(22) Filed: Mar. 9, 2005

(30) Foreign Application Priority Data
Mar. 19, 2004 (TW) 93107520

(51) Int. Cl. H01R 3/00

(52) U.S. Cl. 439/165

(57) ABSTRACT

A folder-type cell phone including a first body and a second body is provided. The housing of the first body is composed of a case and a cover. The second body is connected with the first body by using a hinge structure. The hinge structure includes a shaft, a flexible printed circuit (FPC), a holder, and a bearing. The shaft is formed at an edge of the second body and has a first opening and a second opening at both ends of the shaft. The FPC is arranged in the shaft and has a first end extending toward the second body and a second end passing through the first opening for electrically connecting with the first body. The holder is assembled in the first opening with partially protruding from the shaft for holding the FPC. The hinge is assembled in the second opening with partially protruding from the shaft. Two cylindrical concaves facing upward are formed on a bottom of the case for support the protruding portions of the bearing and the holder so as to pivotally connect the second body with the first body.

### BACKGROUND OF THE INVENTION

(1) Field of the Invention

The invention relates to a hinge structure of a folder-type cell phone and an assembling method thereof, and more particularly to a folder-type cell phone having a hinge structure with complete appearance.

(2) Description of the Prior Art

In resent years, folder-type cell phone has become more and more popular in the market due to its highly variety of appearance available. FIG. 1 shows a typical folder-type cell phone including a first housing 2 and a second housing 4. The first housing 2 has a PCB (not shown) assembled therein for access the signals inputted from a mini keyboard formed on the first housing 2. A flat panel display 6, such as an liquid crystal display (LCD) or an organic light emitting display (OELD), is assembled inside the second housing 4. The second housing 4 is pivotally connected to the first housing 2. Meanwhile, the PCB in the first housing 2 is connected with the flat panel display 6 in the second housing 4 by using a flexible printed circuit (FPC) (not shown) for inputting image signals.

In order to prevent the FPC from being damaged by exposing to exterior environment, the FPC must be properly arranged in a hinge structure, which is also utilized to pivotally connect the first housing 2 and second housing 4. Nowadays, the commonly used hinge structures can be roughly divided into three types described as follows.

Referring to FIG. 2A and FIG. 2B, the first type of the hinge structure is featured in its complete appearance. The hinge structure includes a shaft 21 and a bearing 11. The shaft 21 of the hinge structure is integratedly formed on the second housing 20. The bearing 11 is integratedly formed on the first housing 10. The shaft 21 and the bearing 11 have the dimensions that make them tightly engaged with each other. As shown in FIG. 2B, an FPC 30 is properly placed in an inner space of the hinge structure as a electric signal transmission path between the first housing 2 and the second housing 4. However, as the second housing 20 and the first housing 10 must be deformed for assembly, the FPC 30 inside the hinge structure may be damaged during assembly to decrease the yield. Also, for proceeding such assembly procedure, the first housing 10 and the second housing 20 can be only formed of polymer materials with excellent flexibility to make sure an easily assembly and no permanent deformation existed.

Referring to FIG. 3A, FIG. 3B, and FIG. 3C, the second type of the hinge structure is featured in the sectional appearance. As shown, the hinge structure is divided into a plurality of sections, wherein the sections 222, 224a, and 224b are integratedly formed on the sub housings 22 and 24 of the second housing respectively, and the sections 122, 124a, 124b, and 126 are integratedly formed on the sub housings 12 and 14 of the first housing respectively. By the sectional design, a S-shaped channel is provided between the adjacent sections 124a and 224a located in a middle region of the hinge structure for accommodating the FPC 30 to electrically connect the PCB 50 and the flat panel display 40.

It is noted that the first body and the second body are preferred to be formed of separated sub housings, as indicated in FIG. 3A by labels 12, 14, 22, and 24, rather than an integrated housing. In the assembly procedure, the sub housings 12 and 22 are firstly engaged to each other in order to form the S-shaped channel. Then, the FPC 30 is placed into the S-shaped channel to electrically connect the PCB 50 and the flat panel display 40. Afterward, the sub housings 14 and 24 are assembled on the sub housings 12 and 22 respectively to finish the assembly procedure.

By contrast with the hinge structure shown in FIG. 2A, the present hinge structure has the housings of the first body and the second body formed of separated sub housings 12, 14, 22, and 24 so that the deformation of the hinge structure during assembly procedure, which mat lead to damage the FPC 30, can be prevented. In addition, the sub housings 12, 14, 22, and 24 of the cell phone can be composed of metal materials to present quality appearance. However, in order to provide the S-shaped channel for allocating the FPC 30, the hinge structure must have sectional appearance as shown in FIG. 3C. That is, a plurality of seams b1 through b5 are formed on the hinge structure and badly affect appearance completeness.

Referring to FIG. 4A and FIG. 4B, the third type of the hinge structure is featured in adopting separated bearings 16. In the assembly procedure, the FPC 30 is firstly assembled in the shaft 21 and extending inside the second housing 20. Then, the bearings 16 are assembled to both ends of the shaft 21. Each of the bearings 16 has a curved channel formed therein for accommodating the FPC 30. The inlet and outlet of the curved channel are facing to an opening 18 on the housing 10 and an inner space of the shaft 21 respectively. By attaching the bearing to the first housing 10, therefore, the FPC 30 in the shaft 21 may extend to the first housing through the curved channel in the bearing 16.

The usage of separated bearings 16 in the present hinge structure prevents the need to deform the hinge structure when assembling so as to decrease the possibility of damaged FPC 30. However, this also leads to an existence of seams c between the bearings 16 and the first housing 10 and also badly affects appearance completeness of the hinge structure.

Obviously, according to the various traditional hinge structures mentioned above, it is understood that appearance completeness of the hinge structure may lead to assembling difficulty and reduce the yield. Whereas, the hinge structure designs facilitating assembly may lead to an existence of seams to sacrifice appearance completeness.

Accordingly, how to achieve both the advantages of easily assembly and appearance completeness of the hinge structure has become an important consideration for folder-type cell phone designs.

### SUMMARY OF THE INVENTION

It is a main object of the present invention to overcome the mentioned problems of traditional folder-type cell phones when considering both easily assembly and appearance completeness.

A folder-type cell phone including a first body and a second body is provided in the present invention. The first body has a case and a cover, and the second body is connected with the first body by using a hinge structure. The hinge structure comprises a shaft, a flexible printed circuit (FPC), a holder, and a bearing. The shaft, which is formed at an edge of the second body, has a first opening and a second opening at both ends thereof. The FPC is arranged in the shaft and has a first end extending to the second body for electrically connecting with the second body and a second end passing through the first opening of the shaft for electrically connecting with the first body. The holder is assembled in the first opening to hold the FPC and partially protruding from the shaft. The hinge is assembled in the second opening and partially protruding from the shaft. Two cylindrical concaves facing upward are formed on a bottom of the case and aligning with the both ends of the shaft for supporting the protruding portions of the bearing and the holder so as to pivotally connect the second body and the first body.

The method for assembling the folder-type cell phone in accordance with the present invention comprising the steps of: placing the FPC into the shaft with the first end of the FPC extending toward the second body for electrical connecting with the second body and the second end of the FPC extending through the first opening of the shaft toward the case; inserting the holder into the first opening of the shaft with partially protruding from the shaft to hold the FPC; inserting a bearing into the second opening of the shaft with partially protruding from the shaft; and placing the protruding portions of the holder and the bearing into the cylindrical concaves.

### BRIEF DESCRIPTION OF THE DRAWINGS

The present invention will now be specified with reference to its preferred embodiment illustrated in the drawings, in which

FIG. 1 depicts a schematic view of a traditional folder-type cell phone;

FIG. 2A and FIG. 2B are schematic views of a first type traditional hinge structure;

FIG. 3A through FIG. 3C are schematic views of a second type traditional hinge structure;

FIG. 4A and FIG. 4B are schematic views of a third type traditional hinge structure;

FIG. 5A and FIG. 5B are schematic views of a preferred embodiment of a folder-type cell phone in accordance with the present invention;

FIG. 5C is an exploded view of the folder-type cell phone shown in FIG. 5A;

FIG. 5D is an enlarged view of the hinge structure shown in FIG. 5C with part of the housing shielding the hinge structure removed to show the channel inside the hinge structure;

FIG. 6A through FIG. 6C are schematic views depicting a preferred embodiment of an assembly procedure of the folder-type cell phone in accordance with the present invention; and

FIG. 7 is a schematic view of another preferred embodiment of the folder-type cell phone in accordance with the present invention.

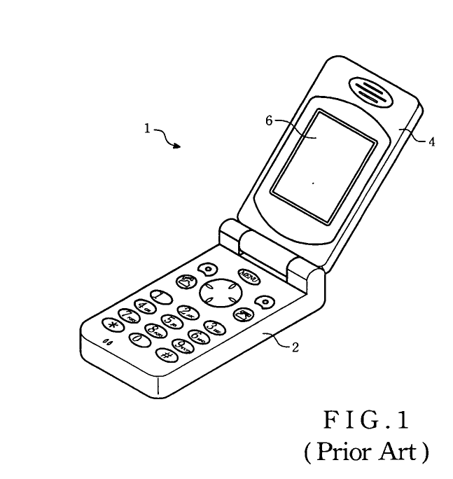

### DESCRIPTION OF THE PREFERRED EMBODIMENT

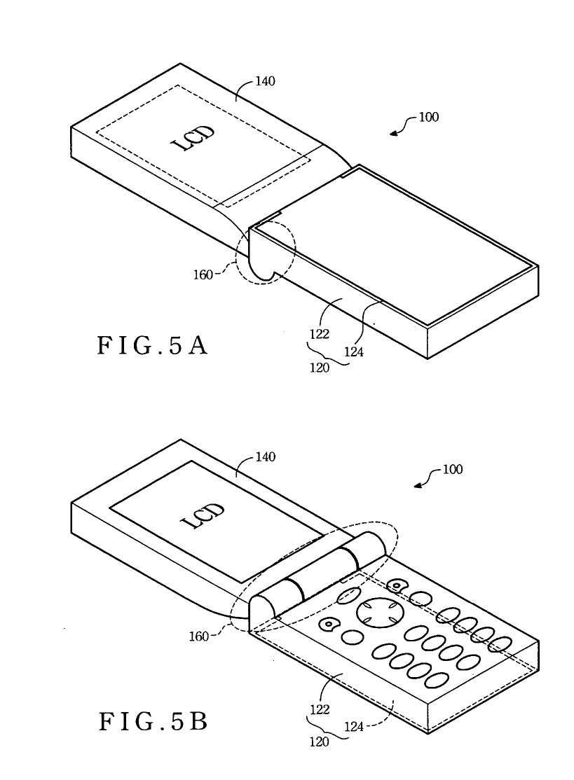

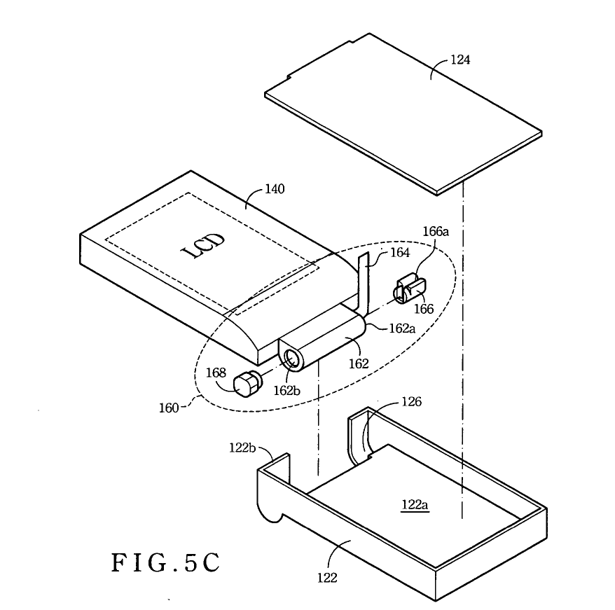

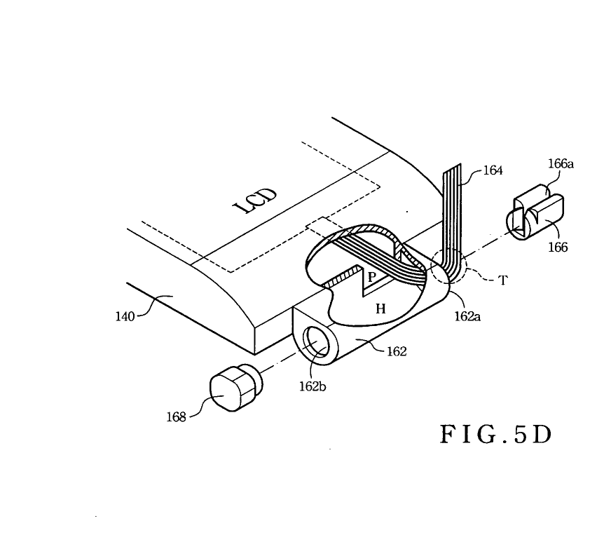

FIG. 5A and FIG. 5B show a preferred embodiment of a folder-type cell phone 100 in accordance with the present invention. The folder-type cell phone 100 includes a first body 120 and a second body 140. The housing of the first body 120 is composed of a case 122, which has a mini keyboard formed thereon, and a cover 124. The second body 140 has a flat panel display 40, such as a liquid crystal display (LCD), and is connected with the first body 140 by using a hinge structure 160.

FIG. 5C shows an exploded view depicting the folder-type cell phone shown in FIG. 5A. The hinge structure 160 includes a shaft 162, a flexible printed circuit (FPC) 164, a holder 166, and a bearing 168. The shaft 162 is formed at an edge of the second body 140. A first opening 162a and a second opening 162b are formed at both ends of the shaft 162. The FPC 164 is arrange in the shaft 162 and has a first end and a second end for electrically connecting with the first body 120 and the second body 140 respectively. The first end is extended toward the interior of the second body 140 (not shown). The second end is extended through the first opening 162a of the shaft 162 toward the case 122 to reach the interior of the first body 120. The holder 166 is assembled in the first opening 162a and partially protruding from the shaft 162 to hold the FPC 164. The bearing 168 is assembled in the second opening 162b of the shaft 162 and partially protruding from the shaft 162. It is noted that both the protruding portions on the bearing 168 and the holder 166 have cylindrical surfaces facing downward. Two cylindrical concaves 126 facing upward are respectively formed on a bottom 122a of the case 122 and adjacent to a sidewall 122b to align with the both ends of the shaft 162. The cylindrical concaves 126 are used for accommodating the protruding portions of the bearing 168 and the holder 166 by matching the cylindrical surfaces so as to pivotally connect the second body 140 and the case 122.

FIG. 5D shows an enlarged view with a cross-section for depicting the interior of the shaft 162 in FIG. 5C. As shown, a channel H is formed in the shaft 162 and extending from the first opening 162a to the second opening 162b. A window P is formed on a sidewall of the channel H for connecting the interior of the shaft 162 with the interior of the second body 140. The FPC 164 has a bent portion T in the middle region for tilting the extending directions of the FPC 164, so as to have the first end of the FPC 164 passing through the window P and extending inside the second body 140 for electrically connecting with the second body 140 and have the second end of the FPC 164 extending through the first opening 162a of the shaft 162. In addition, the holder 166 is inserted into the first opening 162a and has protruding portion extended form the shaft 162. The protruding portion has a radial slit 166a for holding the bent portion T of the FPC 164 and may be utilized for guiding the FPC 164 extending toward the case 122.

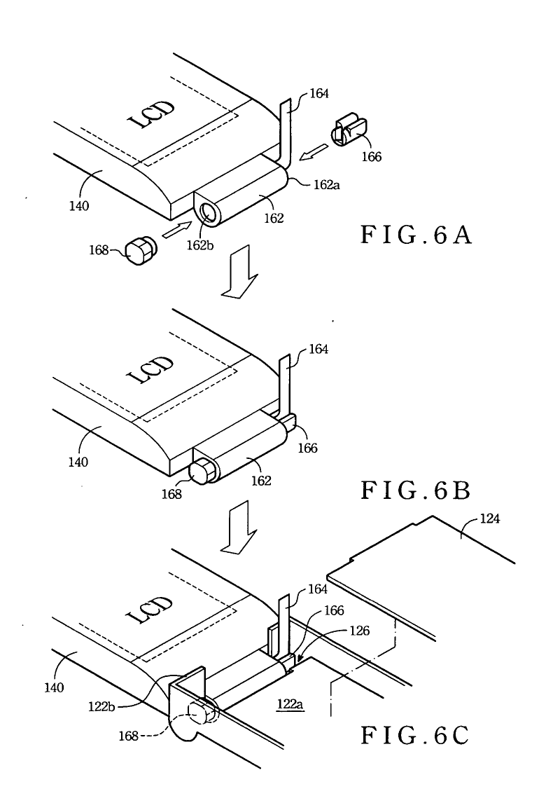

When assembling the folder type cell phone in accordance with the present invention, as shown in FIG. 6A, the FPC 164 is firstly arranged in the shaft 162 by having the first end of the FPC 164 extending to the second body 140 for electrically connecting with the second body 140 and having the second end of the FPC 164 passing through the first opening 162a of the shaft 162 for extending toward the case 122. Then, as shown in FIG. 6B, the holder 166 is inserted into the first opening 162a of the shaft 162 with part of the holder 166 protruding from the shaft 162 to hold the FPC 164. At the same time, the bearing 168 is inserted into the second opening 162b of the shaft 162 with part of the bearing protruding from the shaft 162. Thereafter, as shown in FIG. 6C, the protruding portions of the holder 166 and the bearing 168 are placed to the cylindrical concaves 126 located on the bottom 122a of the case 122 so as to pivotally connect the second body 140 and the case 122. Finally, the cover 124 and the case 122 are integrated with each other to fix the holder 166 and the bearing 168.

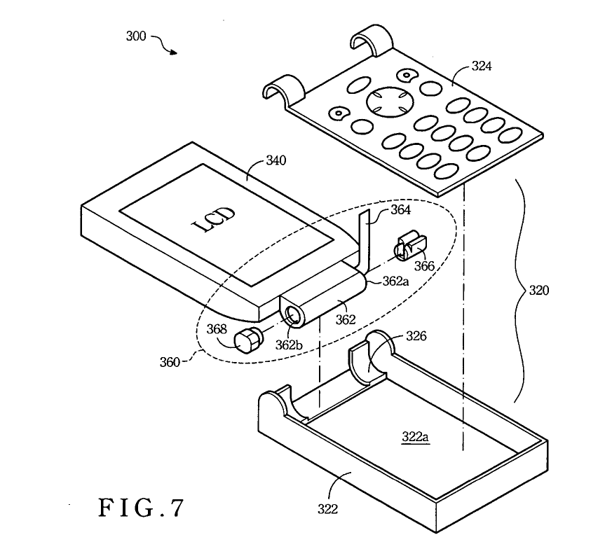

FIG. 7 shows a schematic view depicting another preferred embodiment of the folder-type cell phone 300 in accordance with the present invention. By contrast with the folder-type cell phone 100 of FIG. 5A, the housing of the present first body 320 is composed of a case 322 and a cover 324 with a mini keyboard formed thereon. The second body 340 is connected with the first body 320 by using a hinge structure 360. The hinge structure 360 includes a shaft 362, a flexible printed circuit (FPC) 364, a holder 366, and a bearing 368. The shaft 362 is formed at an edge of the second body 340 and has a first opening 362a and a second opening 362b at both ends of the shaft 362. The FPC 364 is arranged in the shaft 362 and has a first end and a second end for electrically connecting with the first body 320 and the second body 340. The first end is extended to the second body 340 (not shown), and the second end is extended through the first opening 362a of the shaft 362 toward the first body 320.

The holder 366 is assembled in the first opening 362a with partially protruding form the shaft 362 so as to hold and fix the FPC 364. The bearing 368 is assembled in the second opening 362b of the shaft 362 with partially protruding from the shaft 362. Two cylindrical concaves 326 facing upward are formed on the bottom 322a of the case and aligning with the both ends of the shaft 362 for accommodating the protruding portions of the bearing 368 and the holder 366. The cover 324 is assembled onto the case 322 for restricting the position of the holder 366 and the bearing 368.

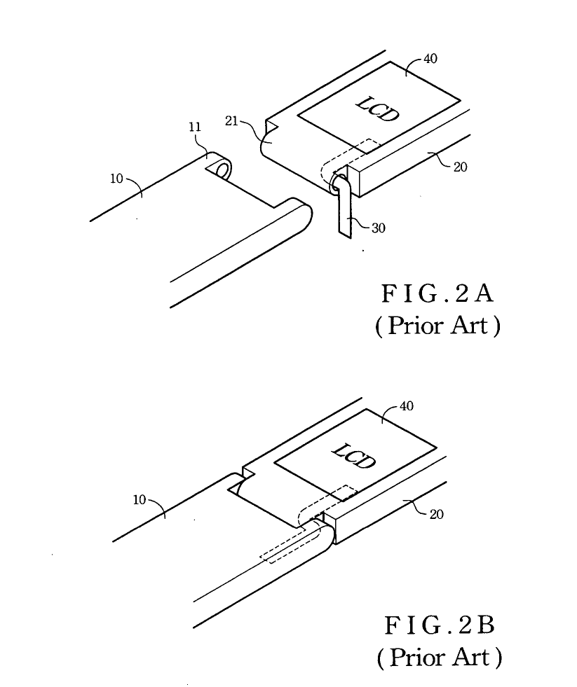

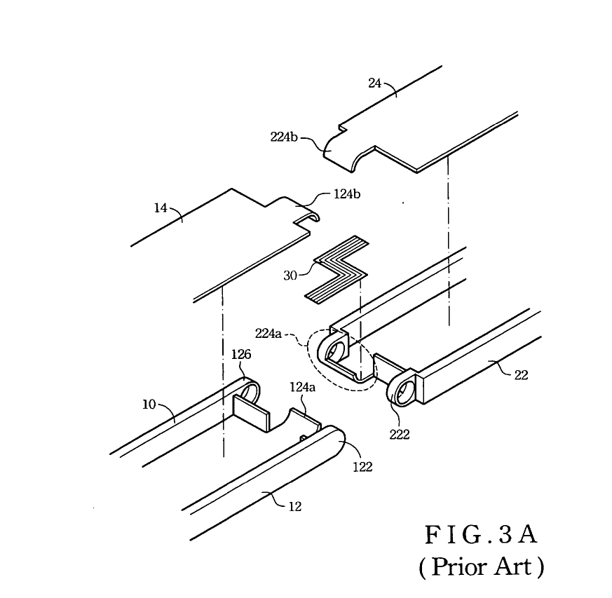

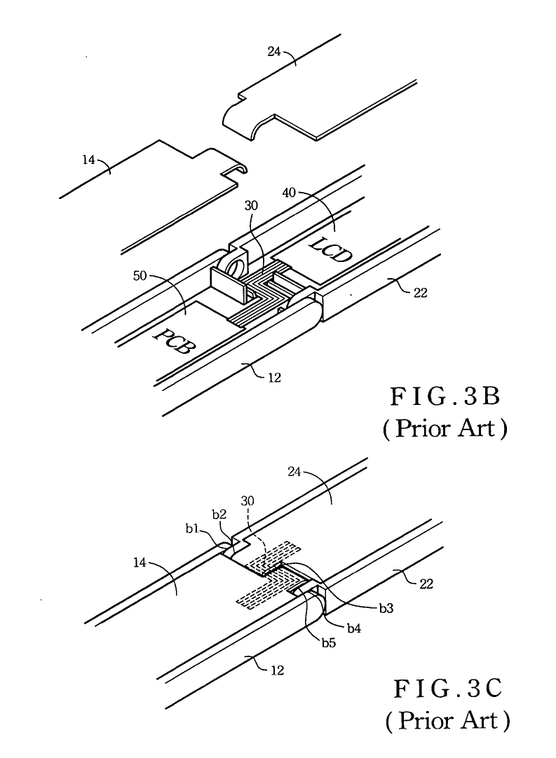

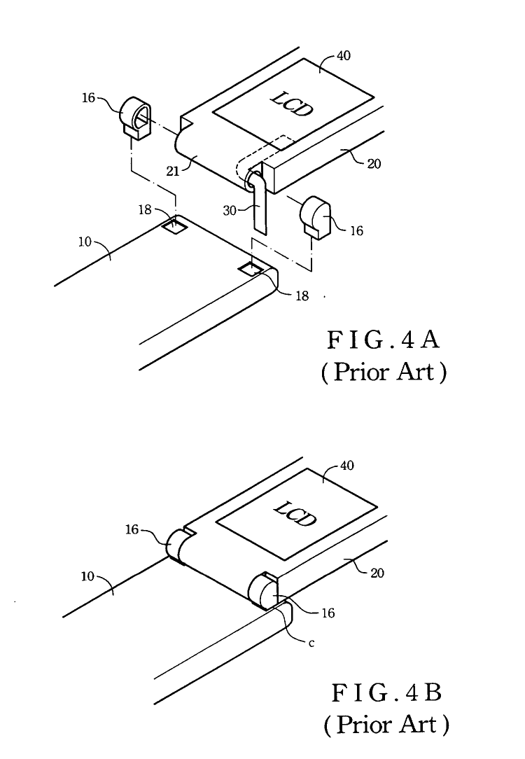

Compared with the traditional folder-type cell phones shown in FIG. 2B, FIG. 3C, and FIG. 4B, the folder-type cell phone in accordance with the present invention has the following advantages.

Firstly, as shown in FIG. 6A through FIG. 6C, the folder-type cell phone 100 in accordance with the present invention features a separated holder 166 for fixing the FPC 164. By using the hinge structure design with the separated holder 166 and bearing 168, the deformation of hinge structure during the assembly procedure can be avoided so as to prevent the FPC 164 from being damaged and increase the yield.

Secondly, as shown in FIG. 5A through FIG. 5D, the holder 166 and the bearing 168 are placed in the cylindrical concaves 126 on the bottom 122a of the case 122 and restricted by the cover 124. That is, some unwanted seams are sheltered by the case 122 and the cover 124 so as to reduce the amount of exposed seams to improve the completeness of the appearance.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

1. A folder-type cell phone comprising:
a first body having a housing composed of a case and a cover;
a second body; and
a hinge structure utilized for connecting the first body and the second body including:
a shaft formed at an edge of the second body and having a first opening and a second opening at both ends thereof;
a flexible printed circuit (FPC) arranged in the shaft having a first end extending toward the second body for electrically connecting with the second body and having a second end passing through the first opening of the shaft for electrically connecting with the first body;
a holder assembled in the first opening to hold the FPC and partially is protruding from the shaft;
a bearing assembled in the second opening and partially protruding from the shaft; and
two cylindrical concaves facing upward formed on a bottom of the case and aligning with the both ends of the shaft for accommodating the protruding portions of the bearing and the holder so as to pivotally connect the second body and the case.

2. The folder-type cell phone according to claim 1, wherein the second body includes a flat panel display therein.

3. The folder-type cell phone according to claim 1, wherein the case includes a mini keyboard thereon.

4. The folder-type cell phone according to claim 1, wherein the cover includes a mini keyboard thereon.

5. The folder-type cell phone according to claim 1, wherein both the bearing and the holder have cylindrical surfaces formed on the protruding portions thereof facing to the respective cylindrical concaves on the bottom of the case.

6. The folder-type cell phone according to claim 1, wherein the holder has a radial slit for holding the FPC.

7. The folder-type cell phone according to claim 1, wherein the FPC has a bent portion held by the holder.

8. A method for assembling a folder-type cell phone by pivotally connecting a first body, which has a housing composed of a cover and a case, and a second body, a shaft having a first opening and a second opening at both ends thereof is formed at an edge of the second body, two concaves facing upward are formed on a bottom of the case and aligning with the both ends of the shaft respectively, the method comprising the steps of:
placing an FPC into the shaft with a first end of the FPC extending to the second body and a second end of the FPC extending through the first opening of the shaft toward the case;
inserting a holder into the first opening with partially protruding from the shaft to hold the FPC;
inserting a bearing into the second opening with partially protruding from the shaft; and
placing the protruding portions of the holder and the bearing into the concaves.

9. The method according to claim 8, after placing the protruding portions of the holder and the bearing into the concaves, further comprising a step of assembling the cover onto the case for restricting the holder and the bearing.

10. The method according to claim 8, wherein the case includes a mini keyboard thereon.

11. The method according to claim 8, wherein the cover includes a mini keyboard thereon.

12. The method according to claim 8, wherein the holder has a radial slit for holding the FPC.

13. The method according to claim 8, wherein the FPC has a bent portion held by the holder.
